(19) United States
(12) Patent Application Publication
(10) Pub. No.: US 2011/0091794 A1
(43) Pub. Date: Apr. 21, 2011

(54) FUEL ELECTRODE MATERIAL AND SOLID OXIDE FUEL CELL INCLUDING THE FUEL ELECTRODE MATERIAL

(75) Inventors: Sang-mock LEE, Yongin-si (KR); Chan KWAK, Yongin-si (KR); Hae-jin HWANG, Incheon (KR); Jong-seol YOON, Incheon (KR); Jun LEE, Incheon (KR)

(73) Assignees: SAMSUNG ELECTRONICS CO., LTD., Suwon-si (KR); SAMSUNG SDI CO., LTD., Suwon-si (KR); INHA-INDUSTRY PARTNERSHIP INSTITUTE, Incheon (KR)

(21) Appl. No.: 12/903,893

(22) Filed: Oct. 13, 2010

(30) Foreign Application Priority Data
Oct. 16, 2009 (KR) 10-2009-0098774

(51) Int. Cl. H01M 8/10; H01B 1/02

(52) U.S. Cl. 429/495; 252/521.1; 252/520.5; 252/520.21

(57) ABSTRACT

A fuel electrode material including a metal oxide having a perovskite type crystalline structure and represented by Formula 1:

A₁₋ₓA′ₓB_{1-y}B′_{y}O₃ Formula 1

wherein A and A′ are different from each other and A and A′ each independently include at least one element selected from the group consisting of strontium (Sr), yttrium (Y), samarium (Sm), lanthanum (La), and calcium (Ca); B includes at least one element selected from the group consisting of titanium (Ti), manganese (Mn), cobalt (Co), iron (Fe), and nickel (Ni); B′ is different from B and includes at least one transition metal; x is about 0.001 to about 0.08; and y is about 0.001 to about 0.5.

### CROSS-REFERENCE TO RELATED APPLICATIONS

This application claims priority to Korean Patent Application No. 10-2009-0098774, filed on Oct. 16, 2009, and all the benefits accruing therefrom under 35 U.S.C. §119, the content of which in its entirety is herein incorporated by reference.

### BACKGROUND

1. Field

The present disclosure relates to a fuel electrode material and a solid oxide fuel cell including the fuel electrode material, and more particularly, to a fuel electrode material with excellent durability and a solid oxide fuel cell including the fuel electrode material.

2. Description of the Related Art

Recently, environmental and energy concerns arising due to the use and depletion of fossil fuels are drawing attention worldwide. To address these problems, great efforts have been devoted to research and commercialization of an improved solid oxide fuel cell (“SOFC”). A SOFC converts chemical energy, generated through the reaction of hydrogen or a hydrocarbon and air, into electrical energy.

When a hydrocarbon is used in a SOFC, carbon is deposited in a fuel electrode when the hydrocarbon is decomposed on the surface of a nickel atom, which is included in the fuel electrode material. The hydrocarbon decomposition products may include coke, which may be formed on the fuel electrode, thereby damaging a SOFC. Attempts have been made to prevent the coking. In particular, research into a perovskite-based fuel electrode material has been conducted.

### SUMMARY

Provided is a fuel electrode material with excellent durability.

Provided is a solid oxide fuel cell (“SOFC”) including the fuel electrode material.

Additional aspects will be set forth in part in the description which follows and, in part, will be apparent from the description.

According to an aspect, disclosed is a fuel electrode material including a metal oxide having a perovskite type crystal structure and represented by Formula 1:

A₁₋ₓA′ₓB_{1-y}B′_{y}O₃ Formula 1

wherein A and A′ are different from each other and A and A′ each independently include at least one element selected from the group consisting of strontium, yttrium, samarium, lanthanum, and calcium, B includes at least one element selected from the group consisting of titanium, manganese, cobalt, iron, and nickel, B′ is different from B and includes at least one transition metal, x is about 0.001 to about 0.08; and y is about 0.001 to about 0.5.

Also disclosed is a solid oxide fuel cell including: a fuel electrode layer; an air electrode layer; and an electrolyte membrane disposed between the fuel electrode layer and the air electrode layer, wherein the fuel electrode layer includes a fuel electrode material including a metal oxide having a perovskite type crystalline structure and represented by Formula 1:

A₁₋ₓA′ₓB_{1-y}B′_{y}O₃ Formula 1

wherein A and A′ are different from each other and A and A′ each independently include at least one element selected from the group consisting of strontium, yttrium, samarium, lanthanum, and calcium, B includes at least one element selected from the group consisting of titanium, manganese, cobalt, iron, and nickel, B′ is different from B and includes at least one transition metal, x is about 0.001 to about 0.08; and y is about 0.001 to about 0.5.

### BRIEF DESCRIPTION OF THE DRAWINGS

These and/or other aspects will become apparent and more readily appreciated from the following description of the embodiments, taken in conjunction with the accompanying drawings in which:

FIG. 1 is a graph of intensity (arbitrary units) versus scattering angle (degrees two-theta, 2θ) illustrating phase analysis results of a fuel electrode material prepared according to Comparative Example 1;

FIG. 2 is a graph of conductivity (siemens per centimeter) versus inverse temperature (inverse kelvin) illustrating electrical conductivity of a fuel electrode material prepared according to Comparative Example 1, wherein the inverse temperature scale has been multiplied by 1000;

FIG. 3 is a graph of intensity (arbitrary units) versus scattering angle (degrees two-theta, 2θ), illustrating phase analysis results of a fuel electrode material prepared according to Comparative Example 2;

FIG. 4 is a graph of conductivity (siemens per centimeter) versus inverse temperature (inverse kelvin) illustrating electrical conductivity of a fuel electrode material prepared according to Comparative Example 2, wherein the inverse temperature scale has been multiplied by 1000;

FIG. 5 is a graph of intensity (arbitrary units) versus scattering angle (degrees two-theta, 2θ), illustrating phase analysis results of a fuel electrode material prepared according to Example 1;

FIG. 6 is a graph of conductivity (siemens per centimeter) versus inverse temperature (inverse kelvin) illustrating electrical conductivity of a fuel electrode material prepared according to Example 1, wherein the inverse temperature scale has been multiplied by 1000;

FIGS. 7 and 8 are Nyquist plots of the imaginary portion of the impedance (ohms square centimeters, Ωcm²) versus the real portion of the impedance (ohms square centimeters, Ωcm²) illustrating impedance spectra of a fuel electrode material prepared according to Comparative Example 3;

FIGS. 9 and 10 are a Nyquist plots of the imaginary portion of the impedance (ohms square centimeters, Ωcm²) versus the real portion of the impedance (ohms square centimeters, Ωcm²) illustrating impedance spectra of a fuel electrode material prepared according to Comparative Example 4; and

FIGS. 11 to 16 are a Nyquist plots of the imaginary portion of the impedance (ohms square centimeters, Ωcm²) versus the real portion of the impedance (ohms square centimeters, Ωcm²) illustrating impedance spectra of a fuel electrode material prepared according to Example 2;

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs.

Electrochemical reactions in a solid oxide fuel cell (“SOFC”) include a positive electrode reaction in which oxygen gas (O₂) at an air electrode is reduced to provide oxygen ions (O²⁻), which migrate through an electrolyte, and a negative electrode reaction in which fuel (H₂ or a hydrocarbon) of a fuel electrode reacts with O²⁻, according to the Reaction Scheme below:

Reaction Scheme

Positive electrode: ½O₂+2e⁻→O²⁻

Negative electrode: H₂+O²⁻→H₂O+2e⁻

Coking is caused by the degradation of hydrocarbon in the fuel electrode through the negative electrode reaction and reduces the lifetime of the fuel electrode. However, the coking in the fuel electrode may be substantially reduced or effectively prevented by using a fuel electrode material having high conductivity and high catalyst activity, and thus the durability of the fuel electrode and the performance of a solid oxide fuel cell (“SOFC”) including the fuel electrode material may be improved.

According to an embodiment, there is provided a fuel electrode material for a SOFC represented by Formula 1 including a metal oxide having a perovskite crystal structure in which a portion of the metal atoms in the metal oxide are substituted with a different chemical element:

A₁₋ₓA′ₓB_{1-y}B′_{y}O₃ Formula 1

wherein A and A′ are different from each other and A and A′ each independently include at least one element selected from the group consisting of strontium (Sr), yttrium (Y), samarium (Sm), lanthanum (La), and calcium (Ca), B includes at least one element selected from the group consisting of titanium (Ti), manganese (Mn), cobalt (Co), iron (Fe), and nickel (Ni), B′ is different from B and includes at least one transition metal, x is about 0.001 to about 0.08; and y is about 0.001 to about 0.5.

The fuel electrode material of Formula 1 may include a metal oxide having a perovskite crystal structure of the general formula ABO₃ in which A and B sites of the metal oxide are each substituted with a different chemical element. In Formula 1, A′ designates an element which substitutes for A on a portion of the A sites in the metal oxide so as to produce an n-type material, improving the electrical conductivity of the metal oxide. In addition, B′ substitutes for B on a portion of the B sites in the metal oxide so as to produce a p-type material, and thus atoms of the B site are easily varied to increase oxygen vacancy concentration. The increase in the oxygen vacancy concentration provides ionic conductivity to a perovskite type material, which increases the area of a triple-phase boundary in which an electrochemical reaction occurs. The increase in the oxygen vacancy concentration also improves the activity of a catalyst for oxidization of hydrogen, which occurs in an anode.

The A site in the fuel electrode material of Formula 1 may include at least one metal element selected from the group consisting of strontium (Sr), yttrium (Y), samarium (Sm), lanthanum (La), and calcium (Ca), and A′, which is substituted for A as a doping element, may include an electron-donor different from A, for example, at least one transition metal. For example, if the A site includes Sr, A′ may include at least one element selected from the group consisting of yttrium (Y), samarium (Sm), and lanthanum (La).

The amount of A′ may be about 0.001 to about 0.08 mole percent (“mol %”), specifically about 0.005 to about 0.05 mol %, more specifically about 0.01 to about 0.05 mol %, based on the total amount of A and A′, but is not limited thereto. If the amount of A′ is within the range described above, the fuel electrode material may have excellent electrical conductivity.

The A′ may include at least two types of elements. If A′ includes two types of elements, the molar ratio between them may be about 0.1:0.9 to about 0.9:0.1, specifically about 0.2:0.8 to about 0.8:0.2, more specifically about 0.3:0.7 to about 0.7:0.3, but is not limited thereto.

The B site in the fuel electrode material of Formula 1 may include at least one metal element selected from the group consisting of titanium (Ti), manganese (Mn), cobalt (Co), iron (Fe), and nickel (Ni), and B′, which is substituted for B as a doping element, may include an electron-acceptor different from B, for example, at least one transition metal or at least one element selected from the group consisting of titanium (Ti), manganese (Mn), cobalt (Co), iron (Fe), and nickel (Ni). For example, if B includes Ti, B′ may include at least one element selected from the group consisting of nickel (Ni) and iron (Fe).

The amount of B′ may be about 0.001 to about 0.10 mol %, specifically about 0.005 to about 0.05 mol %, more specifically about 0.01 to about 0.05 mol %, based on the total amount of B and B′, but is not limited thereto. If the amount of B′ is within the range described above, the fuel electrode material may have excellent ionic conductivity and catalyst activity.

B′ may include at least two types of elements. If B′ includes two types of elements, the molar ratio between them may be in the range of about 0.1:0.9 to about 0.9:0.1, specifically about 0.2:0.8 to about 0.8:0.2, more specifically about 0.3:0.7 to about 0.7:0.3, but is not limited thereto.

As described above, the electrical conductivity, ionic conductivity, and the catalyst activity of the fuel electrode material having the general formula ABO₃, wherein the A and B sites are doped, may be improved by the effects of the doping. Thus, the electrical conductivity may be in the range of about 1 siemen per centimeter (S/cm) to about 100 S/cm, specifically about 5 S/cm to about 90 S/cm, more specifically about 10 S/cm to about 80 S/cm, the ionic conductivity may be about 10⁻⁴ S/cm to about 10⁻² S/cm, about 5.10⁻⁴ S/cm to about 5.10⁻³ S/cm, more specifically about 10⁻³ S/cm, and the catalyst activity may be about 70 kilojoules per mole (kJ/mol) to about 100 kJ/mol, specifically 75 kJ/mol to about 95 kJ/mol, more specifically 80 kJ/mol to about 90 kJ/mol.

In another embodiment, the fuel electrode material may further include an ion conducting oxide to further improve the electrical characteristics of the fuel electrode material. The amount of the ionic conducting oxide may be about 20 to about 50 wt %, specifically about 25 to about 45 wt %, more specifically about 30 to about 40 wt %, based on the total weight of the fuel electrode material.

The ion conducting oxide may include at least one material selected from the group consisting of yttria-stabilized zirconia (“YSZ”), scandia-stabilized zirconia (“SSZ”), samaria-doped ceria (“SDC”), gadolinia-doped ceria (“GDC”), and the like.

The fuel electrode material may further include an electron conducting material. The amount of the electron conducting material may be about 10 to about 50 wt %, specifically about 15 to about 45 wt %, more specifically about 20 to about 40 wt %, based on the total weight of the fuel electrode material. If the amount of the electron conducting material is within the above range, it may ensure sufficient electrical conductivity of the fuel electrode and may significantly decrease a loss in resistance.

The electron conducting material may include at least one material selected from the group consisting of Ni, Cu, and a perovskite oxide, for example, LaMnO₃, LaCoO₃, (La,Sr)MnO₃, (La,Ca)MnO₃, (La,Sr)CoO₃, or (La,Ca)CoO₃. The electron conducting material may also be selected from the group consisting of Ni, Cu, and a combination comprising at least one of the foregoing.

The fuel electrode material described above may be prepared in the following manner.

The fuel electrode material may be prepared by a liquid phase reaction method. According to the liquid phase reaction method, a fuel electrode material precursor is dissolved in a solvent to prepare a precursor solution, the precursor solution is stirred to evaporate the solvent and obtain a solid, the solid is calcined in air, and the calcined product is reduced to obtain a fuel electrode material having a perovskite crystal structure and doping elements.

The fuel electrode material may also be prepared by a solid phase reaction method. For example, fuel electrode material precursor may be mixed and calcined in an inert atmosphere and/or a reducing atmosphere, and the calcined product is pulverized and dried to obtain a fuel electrode material.

The solvent may be, but is not limited to, any solvent that may dissolve the metal oxide precursor: for example, lower alcohols having five or fewer carbon atoms, such as methanol, ethanol, 1-propanol, 2-propanol, or butanol; acid solutions, such as a hydronitric acid solution, hydrochloric acid solution, or a hydrosulfuric acid solution; water; organic solvents, such as toluene, benzene, acetone, diethylether, or ethylene glycol; or a combination comprising at least one of the foregoing.

The fuel electrode material precursor may be a carbonate, oxide, nitrate, sulfate, acetate, chloride, or the like of the metal constituting the fuel electrode material.

The ion conducting oxide or electron conducting material contained in the fuel electrode material may be mixed with the product of the above method or a precursor material according to the method disclosed above.

The fuel electrode material prepared as disclosed above may be used in various industrial fields, for example, in an SOFC.

The SOFC includes: a fuel electrode layer; an air electrode layer; and an electrolyte membrane disposed between the fuel electrode layer and the air electrode layer.

The electrolyte membrane may comprise a composite metal oxide, the electrolyte membrane may comprise a plurality of particles, and the electrolyte membrane may include at least one material selected from the group consisting of zirconium oxide, cerium oxide, and lanthanum oxide, which are known as SOFC electrolyte materials. The electrolyte membrane material may include, for example, yttria-stabilized zirconia (“YSZ”), scandia-stabilized zirconia (“ScSZ”), samaria-doped ceria (“SDC”), gadolinia-doped ceria (“GDC”), or the like. The electrolyte membrane may have a thickness of about 10 nanometers (nm) to about 100 μm, specifically about 100 nm to about 80 μm, more specifically about 1 μm to about 70 μm. Alternatively, the electrolyte membrane may have a thickness of about 100 nm to about 50 μm.

In addition, the air electrode layer may comprise a precious metal, such as platinum (Pt), ruthenium (Ru), or palladium (Pd).

The fuel electrode material having the perovskite type crystal structure of Formula 1 and having doping elements as disclosed above may be used as a material for the fuel electrode layer. Also, particles of the metal oxide, which may be used in the electrolyte membrane, may further be optionally included in the fuel electrode layer.

Hereinafter, an embodiment will be further disclosed in detail with reference to the following examples. However, these examples are not intended to limit the purpose and scope of the embodiments.

### SYNTHESIS EXAMPLE

The following materials were used as starting materials to synthesize a doped SrTiO₃ powder by a solid phase reaction method:

SrCO₃ (Purity: 99.9%, Aldrich Co., Ltd.) and TiO₂ (Purity: 99.9%, High purity Chemicals Co., Ltd.).

The following materials were used as starting materials to substitute the A site:

Y₂O₃ (Purity: 99.9%, Junsei chemical Co., Ltd.), La₂O₃ (Purity: 99.99%, GFS chemical Co., Ltd.), Sm₂O₃ (Purity: 99.99%, Samchun chemical Co., Ltd.); and Yb₂O₃ (Purity: 99.9%, High purity chemicals Co., Ltd.).

The following materials were used as starting materials to substitute the B site:

Cr₂O₃ (Purity: 99.9%, High purity chemicals Co., Ltd.), α-Fe₂O₃ (Purity: 99.99%, High purity chemicals Co., Ltd.); and NiO (Purity: 99.9%, Grand chemical & Materials Co., Ltd.).

The powders of the foregoing materials were prepared to have a selected molar ratio as further disclosed below and sufficiently mixed at 250 revolutions per minute (“rpm”) for 2 hours using a planetary ball mill. The sufficiently dried powder mixture was heated to 1400° C. at a rate of 5° C./min while supplying a gas of 95% Ar and 5% H₂ thereto at a rate of 100 milliliters per minute (ml/min) in an electric tube furnace to provide a reducing atmosphere, and the temperature was maintained for 10 hours to sinter the powder. The sintered powder was pulverized at 350 rpm for 1 hour using the planetary ball mill. After the milling, the resulting material was dried for 24 hours to prepare a desired fuel electrode material.

Preparation of Sample

A sample used to measure electrical conductivity was prepared by uniaxially pressing the synthesized powder to form a monolith having a width of 4 centimeters (cm), a length of 5 millimeters (mm), and a height of 5 mm using a pressure of 700 kilograms (kg) in a square metal mold, and shaping the resulting monolith using a cold isostatic press (“CIP”) at a pressure of 160 megapascals per square centimeter (MPa/cm²). The resulting monolith was heated to 1450° C. at a rate of 5° C./min while supplying a gas of 95% Ar and 5% H₂ thereto at a rate of 100 ml/min in an electric furnace, to provide a reducing atmosphere, and the temperature was maintained at 1450° C. for 10 hours to sinter the sample. The surface of the sintered sample was polished.

### Comparative Example 1

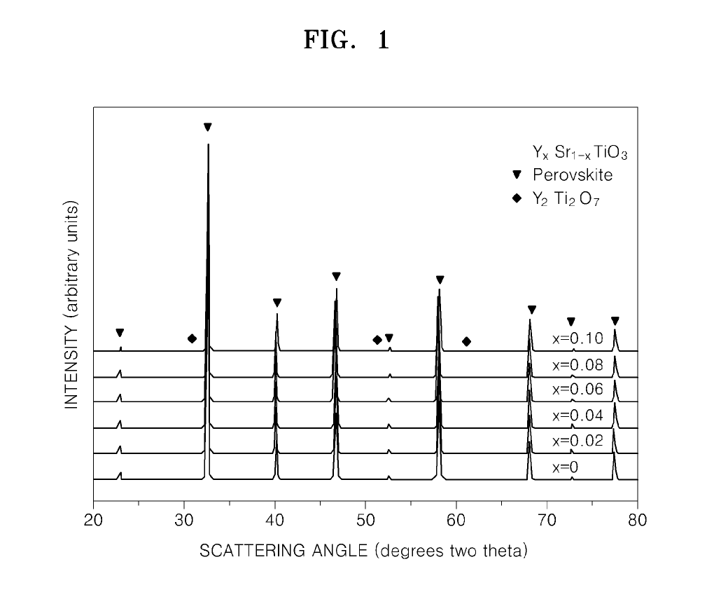

YₓSr₁₋ₓTiO₃ (“YSTO”) having a perovskite structure and the general formula ABO₃ structure and various compositions (x=0, 0.02, 0.04, 0.06, 0.08, 0.10) was synthesized using a solid phase reaction method. FIG. 1 is a graph illustrating phase analysis results of YSTO using X-ray powder diffraction (“XRD”). Referring to FIG. 1, a powder having a single phase perovskite structure may be synthesized when the amount of yttrium was up to 8 mol %. If the amount of yttrium was 10 mol %, a perovskite phase and a second phase of Y₂Ti₂O₇ coexisted.

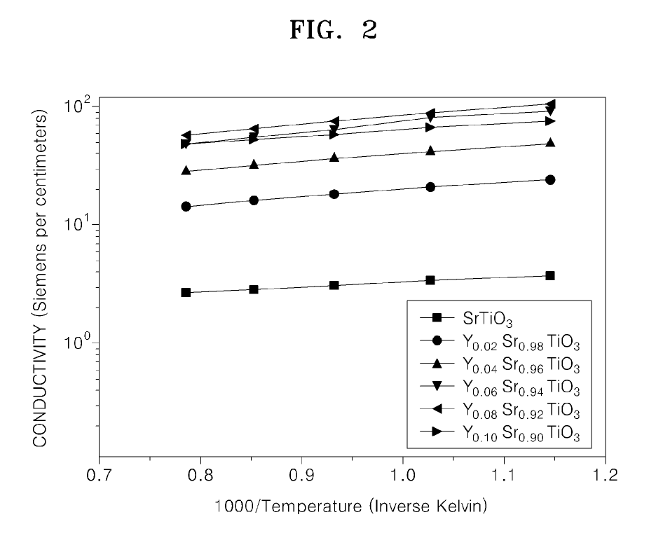

FIG. 2 is a graph illustrating electrical conductivity of YSTO according to the amount of Y. Referring to FIG. 2, the fuel electrode material had a maximum electrical conductivity when the amount of Y was 8 mol %.

### Comparative Example 2

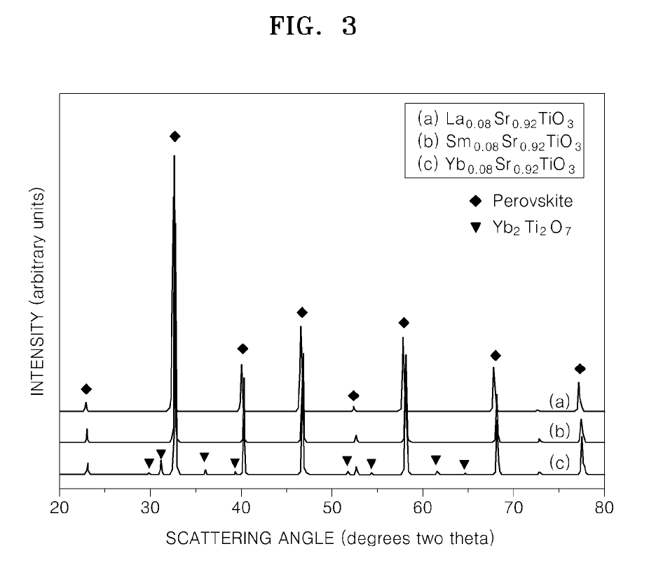

FIG. 3 is a graph illustrating phase analysis results of the fuel electrode materials (La_{y}Y_{1-y})ₓSr₁₋ₓTiO₃, (Sm_{y}Y_{1-y})ₓSr₁₋ₓTiO₃, and (Yb_{y}Y_{1-y})ₓSr₁₋ₓTiO₃ (“LSTO”, “SmSTO”, and “YbSTO”, respectively) prepared by adding 8 mol % of a lanthanum series element, specifically lanthanum, samarium, and ytterbium, respectively, in addition to yttrium, to dope the Sr-site of the SrTiO₃. As shown in FIG. 3, a single phase perovskite structure was obtained when using lanthanum and samarium, but a second phase, Yb₂Ti₂O₇, was observed when using ytterbium.

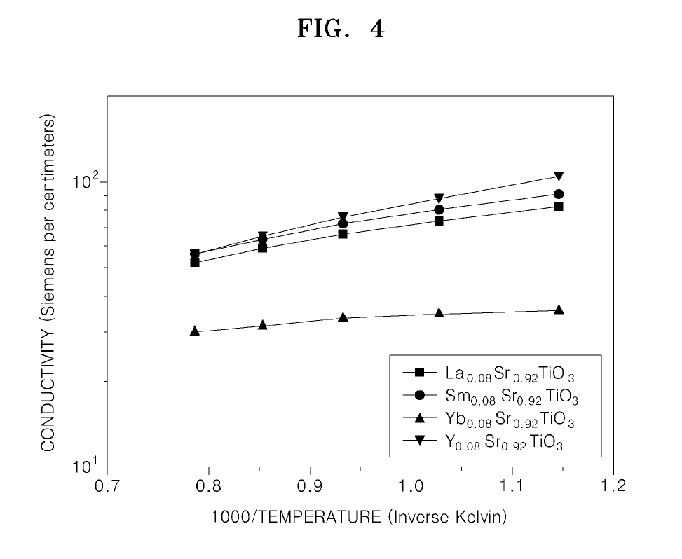

FIG. 4 is a graph illustrating electrical conductivity of a doped SrTiO₃ powder, obtained by adding 8 mol % of a lanthanum series element and sintering, which was measured at a temperature ranging from about 600 to about 1000° C. Generally, the electrical conductivity increased as the temperature decreased. The electrical conductivity shown in FIG. 4 is typical of an n-type semiconductor. Among the materials shown in FIG. 4, SrTiO₃ substituted with yttrium showed a highest electrical conductivity of 105 S/cm⁻¹ at 600° C. SrTiO₃ substituted with ytterbium, in which a second phase was formed, had a lowest electrical conductivity of 35.7 to 29.9 S/cm⁻¹ because the second phase Yb₂Ti₂O₇ functions as an insulator to increase overall resistance, and thus the electrical conductivity of that material was relatively low.

It was identified that Y_{0.08}Sr_{0.92}TiO₃ having a single phase perovskite structure prepared by substituting the Sr-site with a lanthanum series element had the highest electrical conductivity.

### Example 1

A fuel cell desirably has excellent electrical conductivity, ionic conductivity, and catalytic characteristics. The ionic conductivity and catalytic characteristics may be improved by substituting the B-site with a transition metal. The powder was synthesized using a transition metal such as chromium (Cr), iron (Fe), or nickel (Ni), and phase analysis, microstructure identification, and electrical conductivity measurement thereof were conducted.

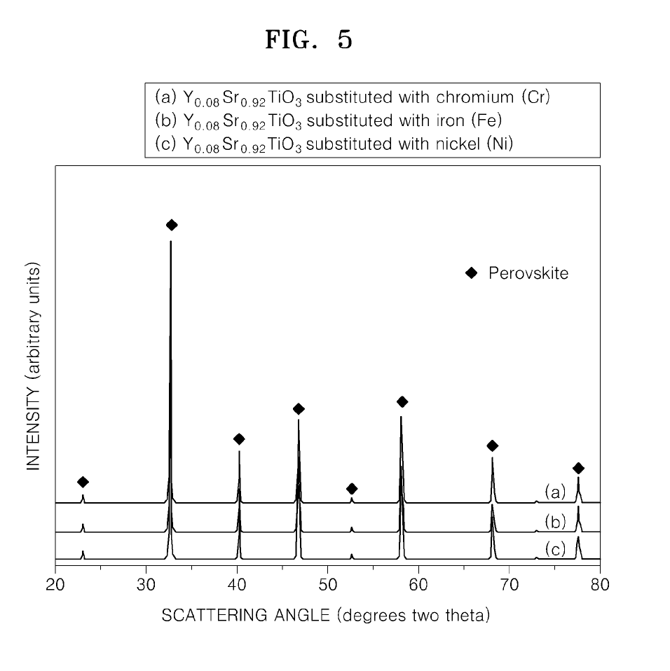

FIG. 5 is a graph illustrating phase analysis results of a fuel electrode material prepared according to Example 1 using XRD. In order to obtain a single phase powder having a perovskite crystalline structure, Y_{0.08}Sr_{0.92}TiO₃ substituted with chromium (Cr) or iron (Fe) (“YSCT” and “YSFT”, respectively) were synthesized in a reducing atmosphere while supplying a gas of 95% Ar and 5% H₂ thereto, and Y_{0.08}Sr_{0.92}TiO₃ powder substituted with Ni (“YSNT”) was synthesized in air to inhibit the reduction of NiO. The B-site was substituted with 5 mol % of each transition metal, and thus the single phase perovskite crystalline structure was obtained.

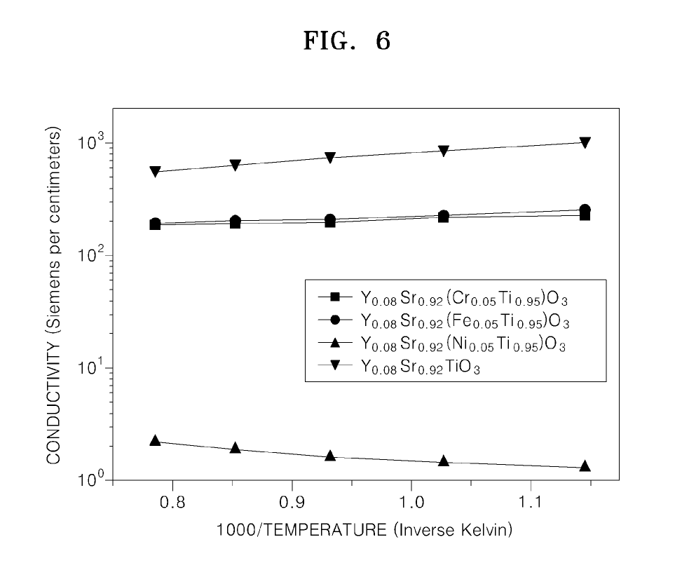

Each synthesized powder was sintered as a square monolith, and the electrical conductivity thereof was measured in a reducing atmosphere (5% H₂+95% Ar). FIG. 6 is a graph illustrating electrical conductivity of Y_{0.08}Sr_{0.92}(M_{0.05}Ti_{0.95})O₃ (M=Cr, Fe, or Ni). Referring to FIG. 6, electrical conductivity of the fuel electrode material having the B-site substituted with the transition metal was lower than that of Y_{0.08}Sr_{0.92}TiO₃ having the unsubstituted B-site. While the electrical conductivity of Y_{0.08}Sr_{0.92}TiO₃ substituted with Cr or Fe increased as the temperature decreased, the electrical conductivity of Y_{0.08}Sr_{0.92}TiO₃ substituted with Ni decreased as the temperature decreased. Because the Y_{0.08}Sr_{0.92}Ni_{0.05}Ti_{0.95}O₃ was synthesized in the air, oxygen ions in a lattice were not emitted, and thus surplus electrons were not generated.

### Comparative Example 3

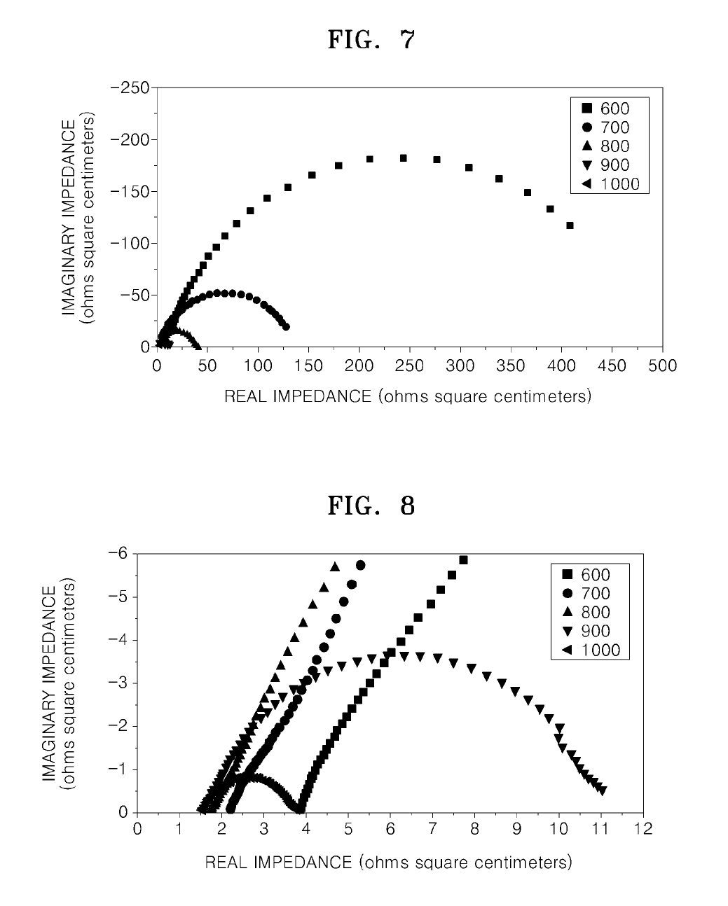

FIGS. 7 and 8 are graphs illustrating impedance spectra of Y_{0.08}Sr_{0.92}TiO₃ with respect to temperature. FIGS. 7 and 8 are graphs of impedance spectra of the same sample while varying the scales of the real axis and imaginary axis. FIG. 7 shows an impedance spectrum of Y_{0.08}Sr_{0.92}TiO₃ at 600, 700, and 800° C., and FIG. 8 shows an impedance spectrum of Y_{0.08}Sr_{0.92}TiO₃ at 900 and 1000° C. A small semicircle was found in a high frequency field, and a large semicircle was found in a middle and low frequency field, regardless of the temperature. Because the semicircle in the high frequency field is smaller than the semicircle in the middle and low frequency field between the two semicircles, the two semicircles were regarded as a single circle in FIG. 7. Polarization resistance was calculated using the difference between a right intercept of the semicircle and a left intercept of the semicircle. The polarization resistance was 2.21 Ωcm² at 1000° C. and increased to about 130 Ωcm² at 700° C. The polarization resistance rapidly increased as the temperature decreased. It was identified that Y_{0.08}Sr_{0.92}TiO₃ had higher polarization resistance than a commercially available Ni/YSZ cermet that is used as a fuel electrode material, and has a low polarization resistance, specifically 0.21 Ωcm² at 1000° C.

### Comparative Example 4

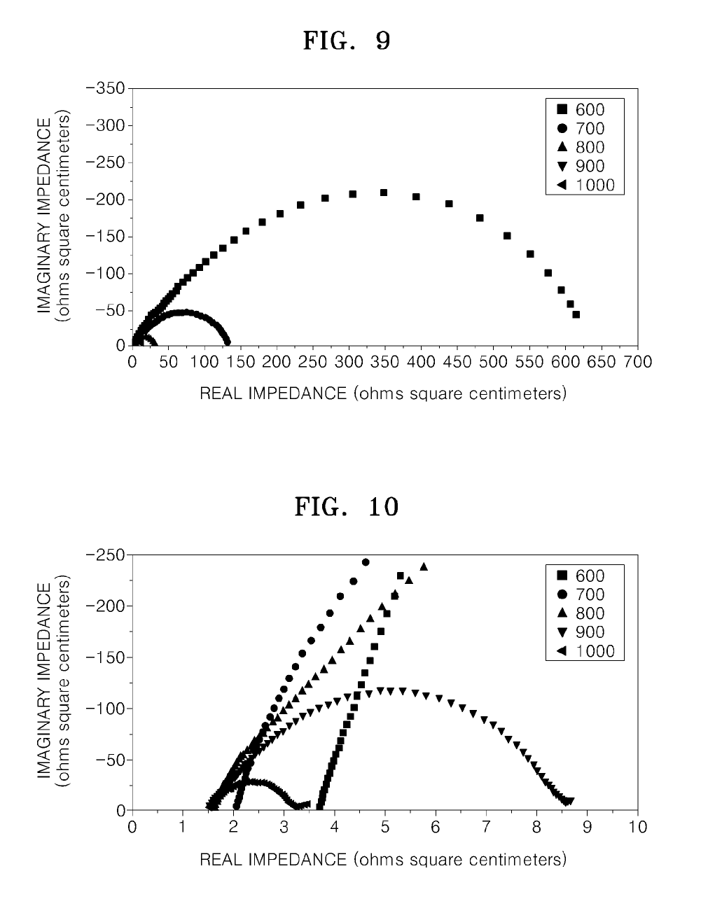

FIGS. 9 and 10 are graphs illustrating impedance spectra of a unit cell comprising LSCF/YSZ/Y_{0.08}Sr_{0.92}(Cr_{0.05}Ti_{0.95})O₃, wherein the virgule distinguishes the electrodes and the electrolyte. According to the impedance spectra, the polarization resistance of SrTiO₃ (“YSCT”), in which a portion of the Sr was substituted with Y and a portion of the Ti was substituted with Cr, was similar to or less than that of a sample in which the Ti was not substituted. The polarization resistance of YSCT was 1.74Ω at 1000° C., which is similar to that of the sample that is not substituted with Cr. Thus, it was identified that the electrical conductivity decreased and the improvement of performance of the fuel electrode was negligible when the Ti site of SrTiO₃, in which the Sr site was substituted with Y, was substituted with Cr.

### Example 2

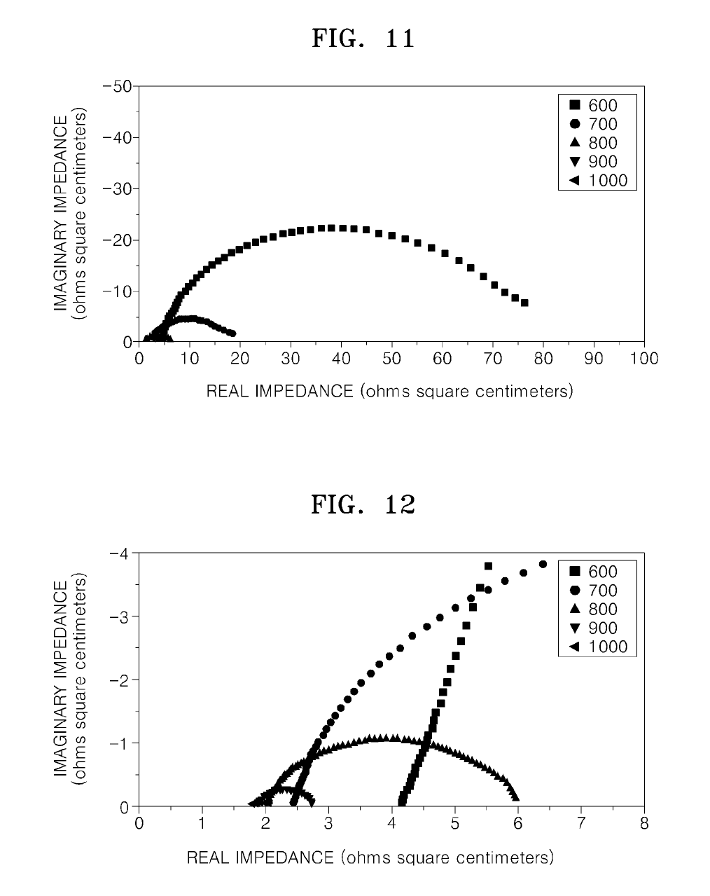

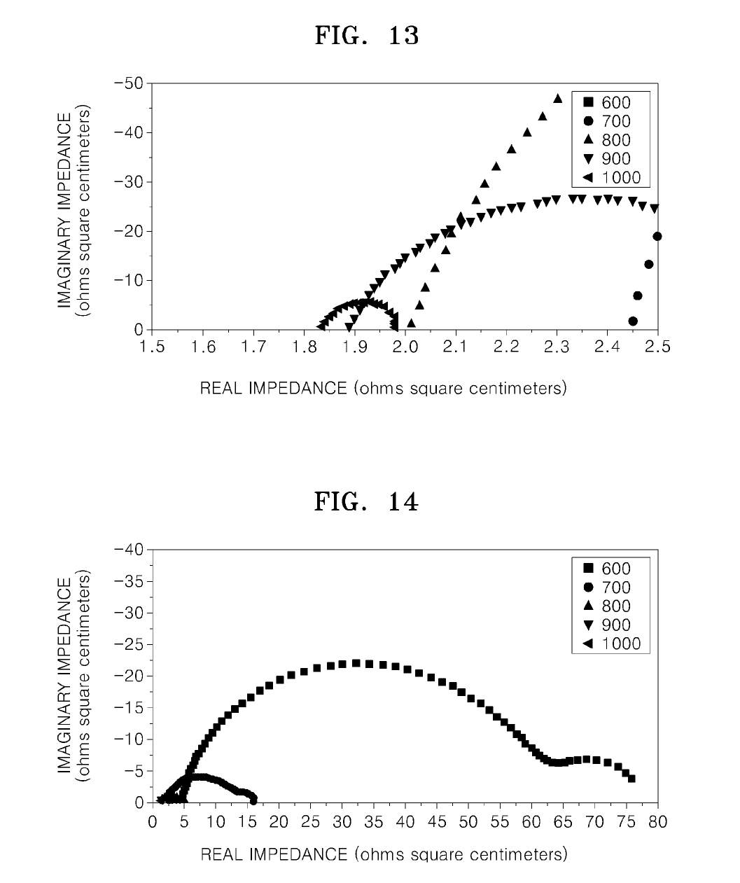

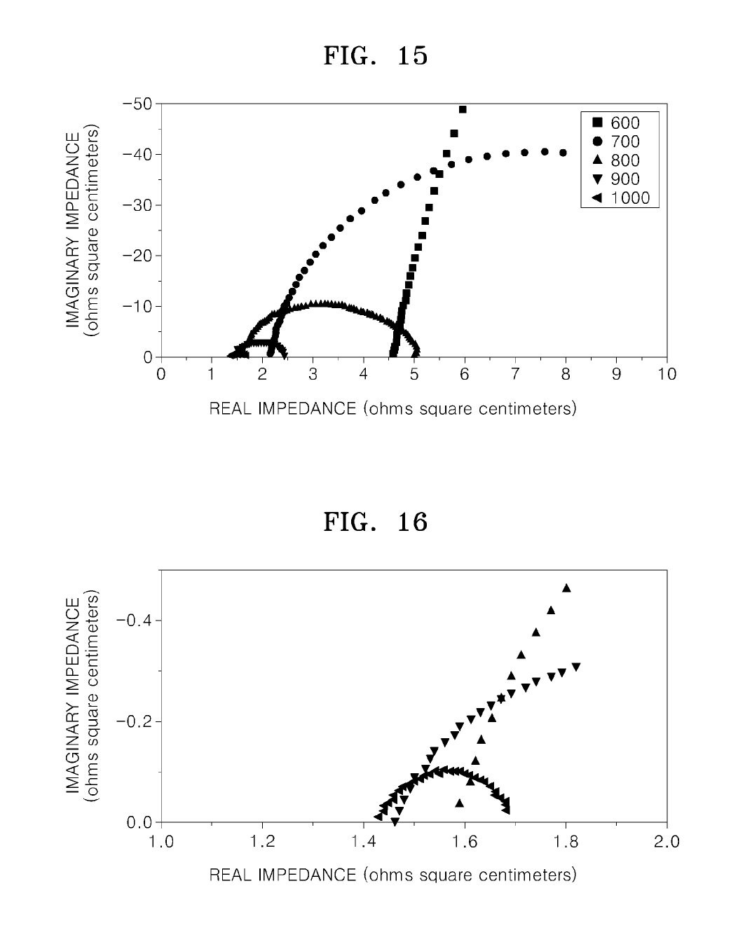

FIGS. 11, 12, and 13 are graphs illustrating impedance spectra of Y_{0.08}Sr_{0.92}(Fe_{0.05}Ti_{0.95})O₃ (“SFT”) in which the B site was substituted with Fe, and FIGS. 14, 15, and 16 are graphs illustrating impedance spectra of Y_{0.08}Sr_{0.92}(Ni_{0.05}Ti_{0.95})O₃ (“SNT”) in which the B site was substituted with Ni. As shown therein, the polarization resistance was significantly reduced. For example, the polarization resistances of SFT and SNT were respectively 0.14Ω and 0.28Ω at 1000° C., and 17.1Ω and 13.8Ω at 700° C. The sample having an unsubstituted B site has polarization resistance of 2.21Ω at 1000° C. and 134.8Ω at 700° C. Thus, the polarization resistance of SFT and SNT was far lower than that of the sample having unsubstituted B site. When the B site was substituted with Ni or Fe, the catalyst activity for the anode reaction significantly increased. In particular, even though the electrical conductivity of Y_{0.08}Sr_{0.92}(Ni_{0.05}Ti_{0.95})O₃ substituted with Ni was relatively low, a very low polarization resistance was obtained. This result indicates that the performance of the electrode is substantially influenced by the catalyst activity of the material, rather than electrical conductivity in a SOFC fuel electrode.

As described above, according to an embodiment, the deposition of carbon in the fuel electrode is inhibited by doping the metal element site of the perovskite type conductive material that is a SOFC fuel electrode material with a different chemical element. As a result, the durability of the fuel electrode may be improved.

It should be understood that the exemplary embodiments described therein should be considered in a descriptive sense only and not for purposes of limitation. Descriptions of features or aspects within each embodiment should be considered as available for other similar features or aspects in other embodiments.

What is claimed is:

1. A fuel electrode material comprising:
a metal oxide having a perovskite type crystal structure and represented by Formula 1:
A₁₋ₓA′ₓB_{1-y}B′_{y}O₃ Formula 1
wherein A and A′ are different from each other and A and A′ each independently comprise at least one element selected from the group consisting of strontium, yttrium, samarium, lanthanum, and calcium,
B comprises at least one element selected from the group consisting of titanium, manganese, cobalt, iron, and nickel,
B′ is different from B and comprises at least one transition metal,
x is about 0.001 to about 0.08; and
y is about 0.001 to about 0.5.

2. The fuel electrode of claim 1, wherein A is Sr, and A′ comprises at least one element selected from the group consisting of Y, Sm, and La.

3. The fuel electrode of claim 1, wherein B is Ti, and B′ comprises at least one element selected from the group consisting of Ni and Fe.

4. The fuel electrode of claim 1, having an electrical conductivity of about 1 siemen per centimeter to about 100 siemens per centimeter.

5. The fuel electrode of claim 1, having a polarization resistance of about 0.1 ohms per square centimeter to about 1 ohm per square centimeter.

6. The fuel electrode of claim 1, further comprising an ion conducting oxide, wherein the amount of the ion conducting oxide is about 20 to about 50 weight percent, based on the total weight of the fuel electrode material.

7. The fuel electrode of claim 6, wherein the ion conducting oxide is selected from the group consisting of yttria-stabilized zirconia, scandia-stabilized zirconia, samaria-doped ceria, gadolinia-doped ceria, and a combination comprising at least one of the foregoing.

8. The fuel electrode of claim 1, further comprising an electron conducting material, wherein the amount of the electron conducting material is about 10 to about 50 weight percent, based on the total weight of the fuel electrode material.

9. The fuel electrode of claim 8, wherein the electron conducting material is selected from the group consisting of Ni, Cu, and a combination comprising at least one of the foregoing.

10. A solid oxide fuel cell comprising:
a fuel electrode layer;
an air electrode layer; and
an electrolyte membrane disposed between the fuel electrode layer and the air electrode layer,
wherein the fuel electrode layer comprises a fuel electrode material according to claim 1.
